(19) United States
(12) Patent Application Publication
(10) Pub. No.: US 2010/0253532 A1
(43) Pub. Date: Oct. 7, 2010

(54) Method of Locating an Emitting Handheld Device and Man/Machine Interface System Implementing Such a Method

(75) Inventors: Florian PERNISEK, Aix-en-Provence (FR); Bruno CHARRAT, Aix-en-Provence (FR)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: INSIDE CONTACTLESS, Aix-en-Provence (FR)

(21) Appl. No.: 12/755,048

(22) Filed: Apr. 6, 2010

(30) Foreign Application Priority Data
Apr. 6, 2009 (FR) 09 01658

(51) Int. Cl. G06F 13/42

(52) U.S. Cl. 340/825

(57) ABSTRACT

A method of locating a handheld device emitting an electric field and/or magnetic field includes defining a reference area, arranging at least one electric field and/or magnetic field probe proximate to or inside the reference area, arranging the handheld device within the reference area, receiving from the probe a detection signal of the electric field and/or magnetic field emitted by the handheld device, and analyzing the detection signal supplied by the probe and determining therefrom the location of the handheld device within the reference area. Embodiments of the invention are applicable to the performance of an interactive action, which is initiated depending upon the location of the handheld device within the reference area.

### BACKGROUND OF THE INVENTION

Embodiments of the invention relate to a method for detecting the location of an object within a reference area. In particular, embodiments of the invention relate to a method of locating a handheld device emitting electric fields and/or magnetic fields within a reference area.

Recently, there has been a growing interest in techniques allowing objects to be located within a reference area, in order to create man/machine interfaces. A simple example of a man/machine interface, and one of the most commonly used, is the mouse of a personal computer.

An innovative man/machine interface is the recently unveiled Microsoft Surface, commercially available from Microsoft Corporation, Redmond, Wash., as disclosed in U.S. Patent Application Publication No 2006/0284874. This patent application discloses a method and an apparatus for the detection of one or more objects relative to a display screen onto which images (such as photos) are projected. An infrared light source directs infrared light towards the display screen. The infrared light is then reflected off of objects located on or near the display screen and this reflected light is captured by a digital video camera. The presence and/or movement of the objects, such as the user's hands, is thus detected by the system, and a computer connected to the projector and to the camera is able to compute, using optical flow algorithms, which action is to be performed and what must be displayed upon the display screen. This application allows one or more users to perform actions such as the translation, rotation, and resizing of items projected onto the display surface.

As wireless and contactless technologies become more and more pervasive, more and more users are equipped with handheld devices, such as mobile telephones, personal digital assistants (PDAs) and the like, which emit radio frequency (RF) or ultra-high frequency (UHF) magnetic or electric fields. For example, Near Field Communication (NFC) devices, such as NFC PDAs or NFC mobile telephones, include an NFC reader that emits an RF magnetic field, oscillating, for example, at 13.56 MHz. In addition, mobile telephones also conventionally emit a UHF electromagnetic field with an electric field component in order to communicate with a cellular telephone network.

### BRIEF SUMMARY OF THE INVENTION

Embodiments of the invention include the observation that the electric fields or magnetic fields emitted by such handheld devices may be used to detect their location or displacement within a reference area.

Embodiments of the invention also include the observation that electric field or magnetic field emitting handheld devices may be used as new types of man/machine interfaces so as to initiate some interactive operations according to their location within a reference area.

More particularly, embodiments of the invention relate to a method of locating a handheld device emitting an electric field and/or magnetic field, such as a mobile telephone emitting an electric field or an NFC device emitting a magnetic field. The method includes defining a reference area, arranging at least one electric field and/or magnetic field probe proximate to or inside the reference area, arranging the handheld device within the reference area, receiving from the probe a detection signal of the electric field and/or magnetic field emitted by the handheld device, and analyzing the detection signal supplied by the probe and determining therefrom the location of the handheld device within the reference area.

According to one embodiment, analyzing the detection signal includes analyzing the magnitude of the detection signal to supply a magnitude value, and determining from the magnitude value the location of the handheld device within the reference area.

According to one embodiment, analyzing the detection signal includes analyzing the phase of the detection signal to supply a phase value, and determining from the phase value the location of the handheld device within the reference area.

According to one embodiment, the method includes arranging at least two electric field and/or magnetic field probes proximate to or inside the reference area, receiving from the probes at least two detection signals, and determining the location of the handheld device within the reference area from the phase difference between the detection signals.

According to one embodiment, the method includes arranging at least two electric field and/or magnetic field probes proximate to or inside the reference area, receiving from the probes at least two detection signals, and determining the location of the handheld device within the reference area from the magnitudes of the detection signals.

According to one embodiment, the method includes arranging at least three electric field and/or magnetic field probes proximate to or inside the reference area, receiving from the probes at least three detection signals, determining a first phase difference between a first pair of detection signals, determining at least a second phase difference between a second pair of detection signals, and determining the location of the handheld device within the reference area from the first and second phase differences.

According to one embodiment, the method further includes defining predetermined locations within the reference area, analyzing the detection signal supplied by the probe, and determining therefrom in which predetermined location the handheld device is located.

According to one embodiment, the method further includes a calibration step including recording, for each predetermined location, a set of magnitude and/or phase values of the detection signals when the handheld device is placed in the location.

Embodiments of the invention also relate to a method for performing at least one interactive action, including locating an emitting handheld device within a reference area according to the method described above, and initiating the interactive action depending upon the location of the handheld device within the reference area.

According to one embodiment, initiating the interactive action includes supplying interactive control signals to an external device configured to perform the interactive action.

Embodiments of the invention also relate to a man/machine interface system for use with a handheld device emitting an electric field and/or magnetic field, such as a mobile telephone emitting an electric field or an NFC device emitting a magnetic field, and includes at least one electric field and/or magnetic field probe supplying a detection signal and a device coupled to the probe. The device is configured to analyze the detection signal, determine therefrom the location of the handheld device within a reference area, and initiate at least one interactive action depending upon the location of the handheld device.

According to one embodiment, the device is configured to determine the location of the handheld device from the magnitude value of the detection signal.

According to one embodiment, the device is configured to determine the location of the handheld device from the phase value of the detection signal.

According to one embodiment, the system includes at least two electric field and/or magnetic field probes proximate to or inside the reference area, supplying detection signals, and the device is configured to determine the location of the handheld device within the reference area from the phase difference between the detection signals.

According to one embodiment, the system includes at least two electric field and/or magnetic field probes proximate to or inside the reference area, supplying detection signals, and the device is configured to determine the location of the handheld device within the reference area from the magnitudes of the detection signals.

According to one embodiment, the system includes at least three electric field and/or magnetic field probes proximate to or inside the reference area. The probes supply detection signals, and the device is configured to determine a first phase difference between a first pair of detection signals, determine at least a second phase difference between a second pair of detection signals, and determine the location of the handheld device within the reference area from the first and second phase differences.

According to one embodiment, the device is configured to memorize predetermined locations within the reference area, associate at least one interactive action to each predetermined location of the handheld device, determine from the detection signal on which predetermined location the handheld device is located, and initiate the interactive action that is associated with the location of the handheld device.

According to one embodiment, the device is configured to perform a calibration step including storing, for each predetermined location, a set of magnitude and/or phase values of the detection signals when the handheld device is placed on the location.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a first embodiment of the method and of the man/machine interface system,

FIGS. 2A, 2B, 2C show a second embodiment of the method,

FIG. 3 shows a second embodiment of the man/machine interface system,

FIG. 4 shows a third embodiment of the man/machine interface system,

FIG. 5 shows a third embodiment of the method, and

FIG. 6 shows a fourth embodiment of the method.

### DETAILED DESCRIPTION OF THE INVENTION

Embodiments of a method of locating an emitting handheld device according to the invention include defining a reference area and arranging electric field and/or magnetic field probes around the reference area. A handheld device emitting an electric field and/or magnetic field is placed within the reference area, and the probes provide detection signals. Each detection signal is the image of the electric or magnetic field emitted by the handheld device as sensed by the considered probe, and its magnitude and phase depend upon the distance of the handheld device with respects to the probe. The detection signals are used to determine the location of the handheld device.

A man/machine interface system receives detection signals supplied by the probes and estimates the location of the handheld device within the reference area. Operations can be assigned to the various locations upon the reference area, and are carried out when a user places the handheld device upon a certain location.

### FIRST EXAMPLE EMBODIMENT OF THE METHOD OF LOCATING AN EMITTING HANDHELD DEVICE

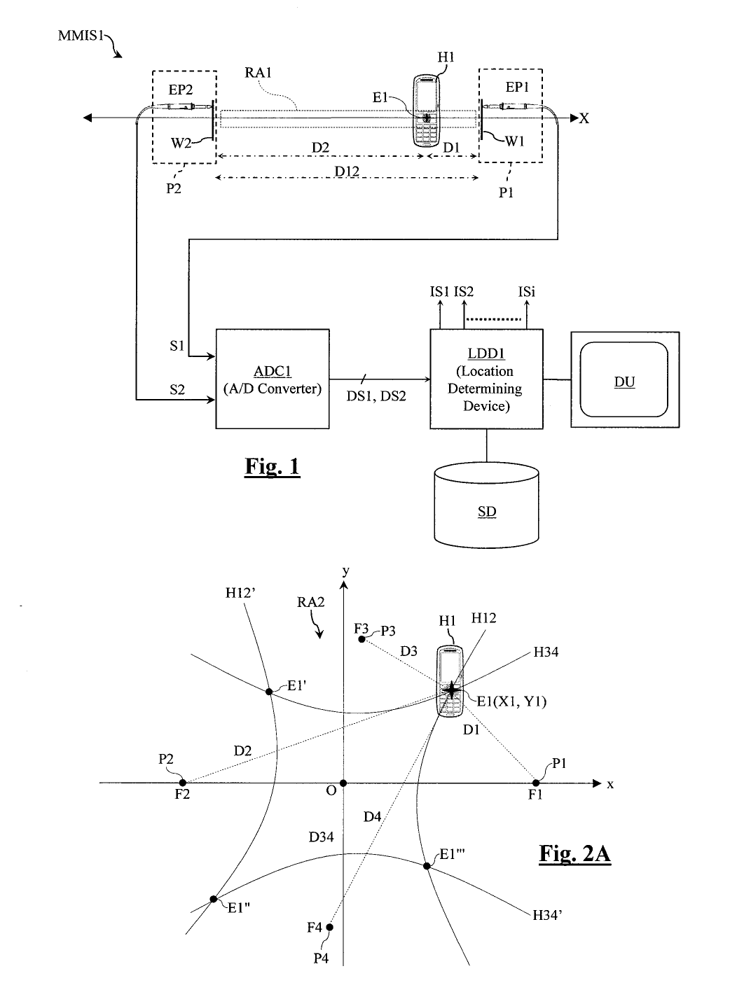

A first embodiment of the method is shown in FIG. 1. A reference area RA1 is defined. The reference area RA1 may be located on a surface such as a table or a desk, the ground, a wall, or the like. Therefore, it may be horizontal, vertical, or have any other orientation or shape, such as square, circular, or the like. The reference area presents a surface area on the order of several tens of centimeters squared to several meters squared maximum, corresponding to the maximum amount of movement that the user of the telephone can do with his arm and possibly his body, in a regularly sized room. Two probes P1, P2 are arranged opposite each other on sides of the reference area RA1.

In this embodiment, reference area RA1 is substantially a one dimensional space along an axis X along which the probes P1, P2 are arranged. The reference area can be considered as a line merged with the axis X, or as a thin rectangle aligned with the axis X, having a small width and a length equal to the distance between the probes P1, P2.

The probes P1, P2 shown in FIG. 1 are electric field probes. Probe P1 includes, for example, a wire W1 and a voltage probe EP1 to sense a voltage in the wire. Likewise, probe P2 includes a wire W2 and an electric field probe EP2 to sense a voltage in the wire W2. Wires W1, W2 are, for example, shaped to form quarter wave antennas and have therefore a length of λ/4, where λ is the wavelength of an electromagnetic wave to be detected, the value of which is given by the relation λ=v/f, v being the speed of the electromagnetic wave emitted by a handheld device H1 and f being the frequency of the electromagnetic wave. For example, in order to detect a 900 MHz signal emitted by a handheld device such as a mobile telephone, each wire W1, W2 has a length of 8.3 cm if v is taken to be the speed of light at approximately 3×10⁸ m/s (i.e. λ=0.333 m).

Probes P1, P2 are separated from each other by a known distance D12. When the handheld device H1 is placed on the reference area RA1, probes P1, P2 sense the electrical field emitted by the handheld device and supply detection signals S1, S2.

The knowledge of distance D12 allows the location of the handheld device along the axis X to be determined without necessitating a calibration step. The location of the handheld device H1 may be determined using the phase difference between signals S1, S2 or the magnitude difference between signals S1, S2, as will be explained below.

### Location of the Emitting Handheld Device Using the Phase Difference Between S1, S2

Since the reference area is here substantially a line or a thin rectangle, distance D12 can be considered as the sum of a distance D1 between probe P1 and the handheld device H1, and a distance D2 between probe P2 and the handheld device. Therefore it can be written that:

D1+D2=D12 (equation 1)

To determine the location of the handheld device within the reference area, D1 and D2 need to be determined. The electromagnetic signal emitted by the handheld device H1 travels at the speed of light, and the phase of signals S1, S2 supplied by probes P1, P2 depend on D1 and D2:

φ1[modulo 2π]=2π*D1/λ (equation 2a)

φ2[modulo 2π]=2π*D2/λ (equation 2b)

It is assumed that the absolute values of the phases φ1, φ2 cannot be measured since the phase at the origin of the emitted wave (i.e. the phase at the location of the handheld device) is not known. However, the phase difference Δφ=φ1−φ2 can be measured and allows D1 and D2 to be determined. In fact, if the distance D12 between the probe is smaller than or equal to the wavelength λ, equations 2a and 2b are no longer modulo 2π and can be written as:

D1=φ1*2π/λ (equation 2a′)

D2=φ2*2π/λ (equation 2b′)

Combining equations 2a′ and 2b′ yields:

D1−D2=Δφ*K1 (equation 3)

with K1=2π/λ and Δφ=φ1−φ2.

Combining equations 1 and 3 yields:

D1=(Δφ*K1+D12)/2 (equation 4)

D2=D12−D1 (equation 5)

Since K1 is known and Δφ can be measured thanks to probes P1, P2, D1 and D2 can be determined by means of equations 4 and 5.

### Location of the Emitting Handheld Device Using the Magnitude of S1, S2

Alternatively, the magnitude of the signals detected by the probes is used to determine the location of the handheld device. Probe P1 detects a signal with magnitude M1 and probe P2 detects a signal with magnitude M2. In a simplifying approximation, it is assumed that the magnitude decreases proportionally to the distance with respect to the emitting handheld device and that the relation between the magnitude and the distance is an affine function F (i.e., linear function with a translation) of the type “−ax+b” with a negative slope. Therefore, it can be written that:

M1=M0−K2*D1 (equation 6a)

M2=M0−K2*D2 (equation 6b)

where M0 is the maximum amplitude sensed when the distance between the probes and the emitting object is null, K2 is a constant representing the slope of the function F that is determined by way of a calibration step.

Combining equations 6a and 6b yields:

D1−D2=−(M1−M2)/K2 (equation 7)

Then, combining equation 7 with equation 1 yields:

D1−(D12−D1)=−(M1−M2)/K2 (equation 8)

or:

2D1=D12−(M1−M2)/K2 (equation 9)

D1=D12/2−(M1−M2)/2K2 (equation 10)

D2=D12−D1 (equation 11)

Since K2 is known and M1−M2 are measured thanks to probes P1, P2, D1 and D2 can be determined using equations 10 and 11.

Alternatively, the calibration step to determine the slope K2 is replaced by a simpler calibration step aiming to determine only the value of the magnitude M0 close to the probes P1, P2. In this case, equations 6a, 6b are written as follows:

M1−M0=−K2*D1 (equation 6a′)

M2−M0=−K2*D2 (equation 6b′)

and are combined by division in order to obtain:

D2/D1=(M2−M0)/(M1−M0)

Designating by “P” the value “(M2−M0)/(M1−M0)”, the following alternative equations 10′, 11′ are obtained:

D1=D12/(1+P) (equation 10′)

D2=D12−D1 (equation 11′)

Since M0 can be determined through a calibration step and M1, M2 can be measured thanks to probes P1, P2, D1 and D2 can be determined using equations 10′ and 11′.

### FIRST EXAMPLE EMBODIMENT OF A MAN/MACHINE INTERFACE SYSTEM

FIG. 1 also shows an embodiment of a man/machine interface system MMIS1 implementing one of the methods described above, or both. System MMIS1 includes probes P1, P2 and further includes an analog-to-digital converter ADC1 and a location determining device LDD1. Detection signals S1, S2 supplied by the probes P1, P2 are digitized by the converter ADC1, which supplies corresponding digitized signals DS1, DS2 to device LDD1. Device LDD1 includes a storage device SD containing programs and algorithms provided to analyze signals DS1, DS2, extract the phase difference or their magnitudes or both, and perform algorithms in order to find distances D1, D2 and thus locate the handheld device H1 according to at least one of the above-described methods. If the method based on a measurement of the magnitudes M1, M2 is used by device LDD1, a calibration step is performed in order to define the constant K2 or to define the magnitude M0 at a null distance from the probes (Cf above alternative equations 10′, 11′). For example, the user is prompted to place the handheld device at two different locations from at least one probe, assuming that the probes are identical, to define K2. Alternatively, if the alternative method is used, the user is prompted to place the handheld device right next to at least one probe, to define M0.

Device LDD1 can optionally be equipped with a display unit DU. The analog-to-digital converter ADC1 may also be a part of device LDD1. In one embodiment, device LDD1 is a personal computer, the storage device SD is a hard disk and the display unit DU is a monitor. The monitor may have a touch screen interface and/or the personal computer may be also equipped with an input device such as a keyboard (not shown).

Once the location of the handheld device has been computed, device LDD1 outputs interactive control signals IS1, IS2 . . . ISi depending upon actions assigned to the various locations of the handheld device. These control signals are used to initiate operations such as “Turn on light”, “Switch off light”, “Turn on television”, “Switch off television, “Turn on radio”, “Switch off radio”, “Next slide”, “Previous slide” (for a picture projection system during a presentation), and the like. These operations are actions defined by the user, an administrator, or by the manufacturer or the supplier of the system.

A preliminary step can be performed before the system is used in order to define the actions to be performed when the handheld device H1 is detected in the various locations upon the reference area. This may consist of choosing actions from a pre-defined menu. For example, the reference area could be divided into several different zones (not shown), such as a zone Z1 near probe P1, a zone Z2 in the center, and a zone Z3 near probe P2.

For ease of use, each location can also be marked with symbols, pictures, words, etc. in order to indicate to the user where the handheld device needs to be placed in order that such action is performed. Pre-configured patterns, such as a light bulb icon to signify that the light will be turned on, may be supplied. Furthermore, these patterns, which may also indicate where to place the probes, can vary according to the type of handheld device to be used, number of probes, size and shape of the reference area, etc.

As another example of use, if the man/machine interface system is connected to an audio system or light, and the movement of the handheld device is used like a slider switch to increase or decrease the volume or the light intensity. The system MMIS1 is configured so that as the handheld device is moved towards probe P1, magnitude M1 increases while magnitude M2 decreases and the volume or light intensity increases. Conversely, as the handheld device is moved towards probe P2, magnitude M2 increases while magnitude M1 decreases, and the volume or light intensity decreases.

In other embodiments, probes P1, P2 may also be magnetic field probes, such as antenna coils configured to sense a magnetic field emitted by a handheld device including an NFC controller. For example, with a 13.56 MHz magnetic field emitted by an NFC mobile telephone complying with the standard ISO 14443 or ISO 15693, the wavelength λ is equal to 22.1 m and represents the maximum distance between probes P1, P2 if the phase difference method is used to locate the handheld device.

### SECOND EXAMPLE EMBODIMENT OF THE METHOD OF LOCATING AN EMITTING HANDHELD DEVICE

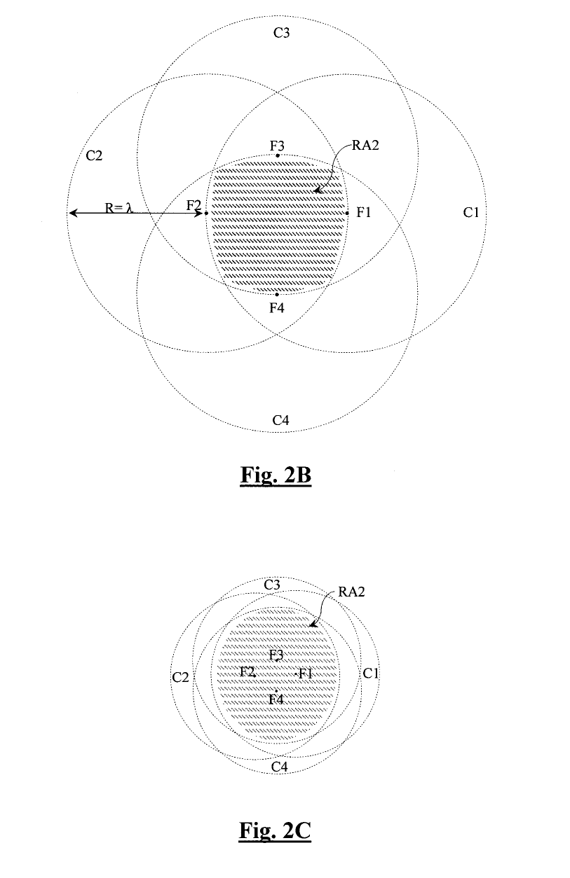

A second embodiment of a method of locating an emitting handheld device within a reference area is illustrated in FIG. 2A. A two dimensional reference area RA2 is defined. Locations within the area are defined with reference to an orthogonal coordinate system Oxy having a center O, an x-axis, and a y-axis. Two probes P1, P2 are arranged opposite each other on sides of the reference area RA2, at points F1, F2 that are, for example, located on the axis X (the x-axis being, for example, defined as passing through F1, F2). Two further probes P3, P4 are arranged opposite each other on other sides of the reference area RA2, for example, at points F3, F4 located for example near the y-axis. It is assumed here that the respective x,y coordinates of points F1, F2, F3, F4 are known. Probes P1-P4 are, for example, electric field probes of the above-described type, or magnetic field probes configured to operate with a NFC handheld device.

The handheld device H1 is then placed within the reference area RA2, at a point E1. Probes P1, P2, P3, P4 sense the electrical field or the magnetic field emitted by the handheld device and supply detection signals S1, S2, S3, S4.

### Location of the Emitting Handheld Device Using the Phase Difference Between S1, S2, S3, S4

The knowledge of the locations F1, F2, F3, F4 in the Oxy coordinate system allows the location of the handheld device within the reference area RA2 to be determined without necessitating a calibration step. The location E1 of the handheld device H1 is determined using the phase difference between signals S1 and S2, S3 and S4. The phases φ1, φ2, φ3, φ4 of signals S1, S2, S3, S4 supplied by probes P1, P2, P3, P4 at points F1, F2, F3, F4 conform to the following equations:

φ1[modulo 2π]=2π*D1/λ (equation 12a)

φ2[modulo 2π]=2π*D2/λ (equation 12b)

φ3[modulo 2π]=2π*D3/λ (equation 12c)

φ4[modulo 2π]=2π*D4/λ (equation 12d)

where D1 is the distance between E1 and F1, D2 is the distance between E1 and F2, D3 is the distance between E1 and F3 and D4 is the distance between E1 and F4. It is again assumed that the absolute values of the phases φ1, φ2, φ3, φ4 cannot be measured since the initial phase of the emitted wave is not known. However, the phase differences φ1−φ2 and φ3−φ4 can be measured.

As the handheld device has been placed off of a line passing through F1 and F2 or off of a line passing through F3 and F4, the sum D1+D2 no longer equals the distance between the probes P1, P2 and the sum D3+D4 is not equal to the distance between the probes P3, P4. Therefore the proportional method described above is inappropriate to determine the values of D1 and D2, or D3 and D4. However, if each distance D1, D2, D3, D4 is smaller than or equal to the wavelength λ, equations 12a to 12d are no longer modulo 2π and can be written as:

D1=φ1*K1 (equation 12a′)

D2=φ2*K1 (equation 12b′)

D3=φ3*K1 (equation 12c′)

D2=φ4*K1 (equation 12d′)

where K1=2π/λ.

Combining equations 12a′ and 12b′ and combining equations 12c′ and 12d′ yields:

D1−D2=(φ1−φ2)*K1 (equation 13a)

D3−D4=(φ3−φ4)*K1 (equation 13b)

Equation 13a is the equation of a first hyperbola having F1 and F2 as focal points and including a series of points at distances D1 and D2 from probes P1 and P2 and for which D1−D2=(φ1−φ2)*K1. The hyperbola can be traced in the Oxy plan as shown in FIG. 2A since φ1−φ2, λ and K1 are known (or its points can merely be calculated by a location determining device). The hyperbola includes curves H12, H12′.

Likewise, equation 13b is the equation of a second hyperbola having F3 and F4 as focal points and including a series of points at distances D3 and D4 from probes P3 and P4 and for which D3−D4=(φ3−φ4)*K1. The second hyperbola can also be traced in the Oxy plan as shown in FIG. 2A, since φ1−φ2, λ and K1 are known, or its points calculated. The hyperbola includes curves H34, H34′.

Once the hyperbolas are traced or merely their points calculated, four intersection points E1, E1′, E1″, E1′41 are found. The point where the handheld device is actually located, here point E1, must be chosen among points E1, E1′, E1″, E1′″. The determination of the actual location among the four possible locations is carried out using the sign of the phase differences or the sign of the differences between the magnitudes M1, M2, M3, M4 of signals S1, S2, S3, S4 to determine in which quadrant of the Oxy plane the searched intersection point is located, the four quadrants being for example defined as for x>0 and y>0, x>0 and y<0, x<0 and y<0, x<0 and y>0.

For example:
the handheld device is located at E1 if φ1−φ2<0 and φ3−φ4<0 because the phase is lower when the handheld device is closer to the considered probe,
the handheld device is located at E1′ if φ1−φ2>0 and φ3−φ4<0,
the handheld device is located at E1″ if φ1−φ2>0 and φ3−φ4>0, and
the handheld device is located at E1′″ if φ1−φ2<0 and φ3−φ4>0.

Using the magnitudes M1, M2, M3, M4:
the handheld device is located at E1 if M1−M2>0 and M3−M4>0, because the magnitude is greater when the handheld device is closer to the considered probe,
the handheld device is located at E1′ if M1−M2<0 and M3−M4>0,
the handheld device is located at E1″ if M1−M2<0 and M3−M4<0, and
the handheld device is located at E1′″ if M1−M2>0 and M3−M4<0.

In an embodiment, the identification of the quadrant in which the handheld device is located, i.e., the quadrant in which the searched intersection point is located, is done before the intersection of the hyperbolas is searched, in order to simplify the calculation by avoiding having to search for the four intersection points.

For the sake of illustration, FIG. 2B schematically shows the shape of reference area RA2 obtained with the four probes located at points F1, F2, F3, F4, within which the distances D1, D2, D3 and D4 are smaller than or equal to the wavelength λ. The reference area RA2 is represented as a shaded region and corresponds to the intersection area of four circles C1, C2, C3, C4 respectively centered at points F1, F2, F3, F4 and each having a radius R equal to λ. In this example, the distance between F1 and F2 and the distance between F3 and F4 is close to λ and F1−F4 are located near the boundaries of the reference area. As another example, FIG. 2C schematically shows the shape of reference area RA2 when the distance between F1 and F2 and the distance between F3 and F4 is much less than λ. In this case F1, F2, F3, F4 are located within the reference area RA2.

It will clearly appear to the skilled person that the embodiment of the method that has just been described is susceptible of various embodiments. For example, instead of measuring the phase differences φ1−φ2, φ3−φ4, the method may use the phase differences φ1−φ3, φ2−φ4 and the corresponding hyperbolas and their intersection points, or the phase differences φ1−φ4, φ2−φ3 and the corresponding hyperbolas and their intersection points. Also, instead of using four probes, only three probes P1, P2, P3 may be used, and the method may use the phase differences φ1−φ3, φ2−φ3 and the corresponding hyperbolas and their intersection points.

### Location of the Emitting Handheld Device Using the Magnitude of S1, S2, S3, S4

The location of the handheld device can also be carried out by way of a measure of the magnitude of signals S1−S4. As described above, it can be written:

M1−M0=−K2*D1 (equation 6a′)

M2−M0=−K2*D2 (equation 6b′)

M3−M0=−K2*D3 (equation 6c′)

M4−M0=−K2*D4 (equation 6d′)

where M0 is the maximum amplitude sensed when the distance between the probes and the emitting object is null, and K2 is the slope of the previously mentioned affine function F. Therefore it can be written:

D1−D2=−(1/K2)*(M1−M2) (equation 14a)

D3−D4=−(1/K2)*(M3−M4) (equation 14b)

Equation 14a is the equation of a first hyperbola having F1 and F2 as focal points and including a series of points at distances D1 and D2 from probes P1 and P2 and for which D1−D2=−(1/K2)*(M1−M2). The hyperbola can be traced in the Oxy plan if K2 is known (or its points can merely be calculated by a location determining device). Equation 14b is the equation of a second hyperbola having F3 and F4 as focal points and including a series of points at distances D3 and D4 from probes P3 and P4 and for which D3−D4==−(1/K2)*(M3−M4). The second hyperbola can also be traced in the Oxy plan, or merely its points calculated. Once the hyperbolas are traced or merely their points calculated, four intersection points E1, E1′, E1″, E1′″ are found as previously. The point where the handheld device is actually located, here point E1, must be chosen among points E1, E1′, E1″, E1′″. The determination of the actual location among the four possible locations is carried out using the sign of the differences between the magnitudes M1, M2, M3, M4 of signals S1, S2, S3, S4 to determine in which quadrant of the Oxy plane the searched intersection point is located, or the sign of the phase differences. The quadrant can also be determined before the hyperbolas are calculated, so as to reduce the number of points of the hyperbolas that must be calculated.

### SECOND EXAMPLE EMBODIMENT OF A MAN/MACHINE INTERFACE SYSTEM

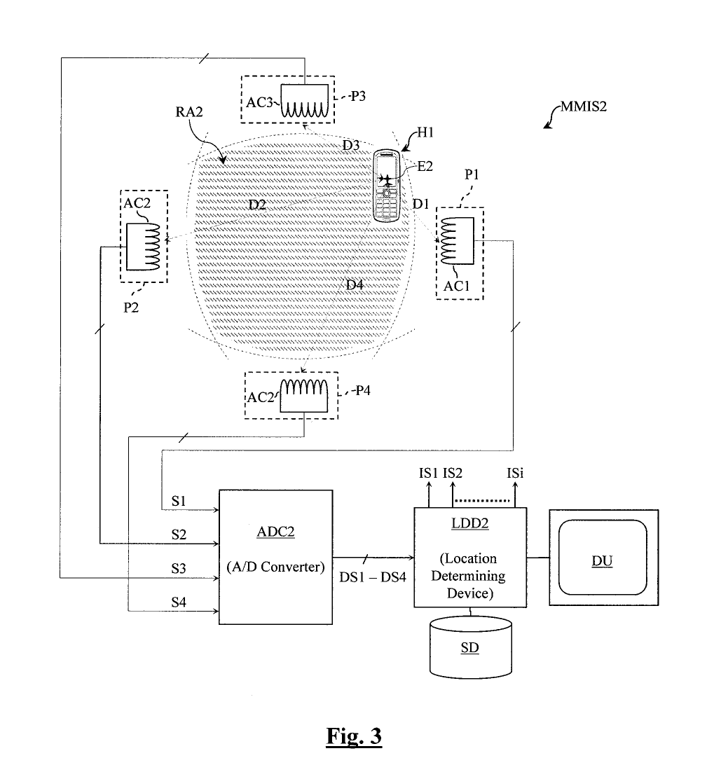

FIG. 3 shows another embodiment of a man/machine interface system MMIS2 configured to implement the second method described above. System MMIS2 includes probes P1 to P4. In this embodiment, probes P1-P4 are magnetic field probes, each including an antenna coil AC1-AC4. The locations of the probes are stored in device LDD2, by the user or when the system is configured at the factory. The antenna coils detect a magnetic field emitted by the handheld device, which can, for example, be an NFC-equipped device complying with the standard ISO 14443 or ISO 15693 and emitting a 13.56 MHz magnetic field (λ=22.1 m). In other embodiments, probes P1-P4 may be dipole antennas configured to detect a UHF electric field emitted by a UHF reader (i.e. a reader provided for UHF transponders or contactless chips).

Like the previously described system MMIS1, system MMIS2 includes an analog-to-digital converter ADC2, a location determining device LDD2 and optionally a storage unit SD and a display unit DU.

When the handheld device H1 is placed on the reference area RA2, probes P1-P4 supply detection signals S1-S4, respectively. The detection signals are digitized by the ADC2 converter, which then supplies digitized signals DS1′-DS4′ to device LDD2. Device LDD2 performs the following steps:
measuring φ1−φ2,
measuring φ3−φ4,
(optional) measuring M1−M2,
(optional) measuring M3−M4,
finding the intersection points E1, E1′, E1″, E1′″ of hyperbolas H12, H12′ and H34, H34′ defined by equations 13a and 13b, and
determining the actual location of the handheld device among the four intersection points using the sign of the phase differences φ1−φ2, φ3−φ4 and/or using the sign of the magnitude differences M1−M2, M3−M4.

According to the variant described above, device LDD2 may also first search for the quadrant in which the handheld device is located, and then search only the intersection point(s) of the hyperbolas that are located within that quadrant.

Once the location of the handheld device has been computed, device LDD2 outputs interactive control signals IS1, IS2 . . . ISi depending upon actions assigned to the various locations of the handheld device. These control signals are used to initiate operations (Cf. examples described above).

A preliminary step can be performed before the system is used in order to define the actions to be performed when the handheld device H1 is detected in the various locations upon the reference area. This may consist of choosing actions from a pre-defined menu. For example, the reference area could be divided into several different zones (not shown), for example ten different zones Z1 to Z10, each be assigned to a specific action.

As indicated above, instead of measuring the phase differences φ1−φ2, φ3−φ4, system MMIS2 may measure the phase differences φ1−φ3, φ2−φ4 and determine the intersection points of the corresponding hyperbolas, or may measure the phase differences φ1−φ4, φ2−φ3 and determine the intersection points of the corresponding hyperbolas. Also, instead of including four probes, system MMIS2 may include only three probes P1, P2, P3, and may be configured to measure the phase differences φ1−φ3, φ2−φ3 and determine the intersection points of the corresponding hyperbolas. System MMIS2 may also include more than four probes, for example ten probes arranged at different locations near the boundaries of the reference area.

In another embodiment, device LDD2 performs the following steps:
measuring K2 (calibration step),
measuring M1,
measuring M2,
measuring M3,
measuring M4,
finding the intersection points E1, E1′, E1″, E1′″ of hyperbolas defined by equations 14a and 14b, and
determining the actual location of the handheld device among the four intersection points using the sign of the magnitudes differences M1−M2, M3−M4.

In a variant of this embodiment, only three probes are used in conjunction with the following equations:

D1−D2=−(1/K2)*(M1′−M2′) (equation 15a)

D1−D3=−(1/K2)*(M1′−M3′) (equation 15b)

### OTHER EMBODIMENTS OF THE METHOD AND OF THE MAN/MACHINE INTERFACE SYSTEM

In other embodiments, the method of locating the emitting handheld device may include a calibration step aiming to memorize different magnitude or phase values in connection with predetermined locations of the handheld device. In this case, the user first defines the reference area RA1 or RA2 and arranges the probes P1, P2 or P1, P2, P3, or P1 to P4, on sides of the reference area. Then the user activates a configuration menu in device LDD1 or LDD2 and provides it with some minimal information such as the number of locations within the reference area he wishes to define and the number of probes.

Device LDD1 or LDD2 then asks the user to place the handheld device in the different declared locations, preferably while keeping the same orientation of the handheld device. Each probe senses the field emitted by the handheld device. The digitized detection signals DS1, DS2 or DS1−DS3 or DS1−DS4 are analyzed by device LDD1 or LDD2 so as to collect information concerning the magnitude and/or phase difference of signals S1, S2 or S1−S3 or S1−S4 in connection with each location. These measurements are preferably repeated until a set of values has been collected for each probe and each location. The variations of the values measured in each location represent the variations that may be encountered during operation, for example if the user does not place the handheld device on the locations with exactly the same orientation each time, or if different handheld devices are used. Once the magnitude and/or phase values of the detection signals have been recorded for each probe and each location, operations can be assigned to each location. The ability of the system to discriminate different locations may be taken into consideration. For example, if the locations are too close together or there is not enough of a difference in magnitude or phase from one location to another, the system may not be able to determine what operation the user wishes to perform. In that case, the user may be requested to choose a larger pitch for the locations by extending the size of the reference area or by lowering the number of locations within the reference area. Alternatively, the user could add additional probes or re-position the probes.

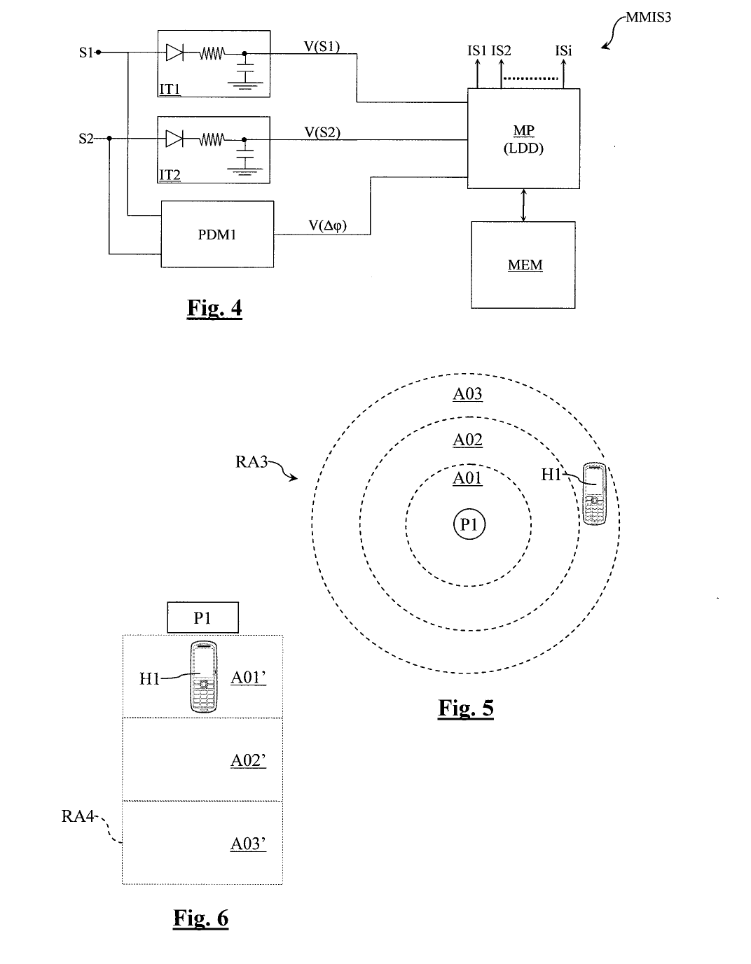

FIG. 4 shows a third embodiment of a man/machine interface system MMIS3 according to the invention (the reference area and probes are not shown). System MMIS3 includes two integrators IT1, IT2, a phase difference detection module PDM1, a microprocessor MP, and a memory MEM. Each integrator IT1, IT2 includes, for example, a diode, a resistor, a capacitor and a connection to ground. Integrators IT1, IT2 receive AC detection signals S1, S2 from probes P1, P2 and convert them into demodulated direct current (DC) voltages V(S1) and V(S2), the values of which are a function of the amplitude of signals S1, S2 and which are supplied to the microprocessor MP. The phase difference detection module PDM1 can be of either analog or wired-logic type. Module PDM1 receives alternating current (AC) signals S1, S2 and supplies the phase difference Δφ=φ(S1)−φ(S2) to microprocessor MP as a DC voltage V(Δφ), the value of which is a function of the phase difference.

Microprocessor MP receives signals V(S1), V(S2), V(Δφ) and performs location determination according to at least one of the above-described methods. Signals IS1, IS2 . . . ISi are supplied to external devices (not shown). In this embodiment, it is not necessary to perform a digitization of signals 51, S2. Obviously, this embodiment can be extended to more than two probes through the addition of further integrators and phase detection modules.

FIG. 5 shows an embodiment of the method according to the invention wherein a single probe is used. A probe P1 is located at the center of a circular reference area RA3 with several circular and concentric locations, A01, A02, A03. The circular shape of the reference area RA3 allows, for example, several users around a table to use a mobile telephone H1 one after the other to initiate different interactive actions.

Alternatively, FIG. 6 shows a probe P1 arranged upon one side of a reference area RA4, which includes several locations such as A01, A02, A03 or more. The magnitude of the detected signal decreases as the handheld device is moved away from the probe.

Various other embodiments of the method of locating an emitting handheld device may be provided by those skilled in the art. As previously indicated, NFC handheld devices are fitted with an NFC reader that emits a magnetic field and can be detected by magnetic field probes, for example, probes with sensing antenna coils, Hall effect probes, or the like.

In addition, in some embodiments, the location determining device LDD1 LDD2 performs other calculations to determine, based upon changes in locations of the handheld device, the speed of displacement, as well as variations in speed (i.e., accelerations and decelerations). Actions are associated with a variation of speed above a first threshold and/or below a second threshold. For example, slowly moving the handheld device towards probe P1 moves to the next slide in a visual presentation, while quickly moving the handheld devices towards probe P1 skips to the end of the visual presentation.

The handheld device may also be an electronic token including a power source and able to emit an electrical field, a magnetic field, or both.

Those skilled in the art will also note that the term “location” may include different meanings depending upon the embodiment of the invention, and that the term “area” should not be construed as being specifically limited to a one-dimensional or a two dimensional space. In fact, the detection of movements of the handheld device may be extended along axes that are perpendicular to the work surface, thereby defining a three dimensional reference space.

Those skilled in the art will also note that different handheld devices, such as a mobile telephone and an NFC device, can be used within a single detection area, provided that they do not operate at exactly the same frequency or that fields of different types are used to differentiate the one from the other—for example the electric field emitted by a mobile telephone and the magnetic field emitted by an NFC mobile telephone or an NFC device. The sets of values for the mobile telephone are programmed to perform a certain set of interactive actions, whilst the sets of values for the NFC telephone or device are configured to perform a different set of interactive actions.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for performing at least one interactive action using a man/machine interface system, the method comprising:
locating a handheld device emitting an electric field and/or magnetic field, the handheld device being located by:
defining a reference area,
arranging at least one electric field and/or magnetic field probe proximate to or inside the reference area,
arranging the handheld device within the reference area,
receiving from the probe a detection signal of the electric field and/or magnetic field emitted by the handheld device, and
analyzing the detection signal supplied by the probe and determining therefrom the location of the handheld device within the reference area; and
initiating the interactive action using the man/machine interface system, depending upon the location of the handheld device within the reference area, the action being initiated by supplying interactive control signals to an external device configured to perform the interactive action.

2. The method according to claim 1, wherein analyzing the detection signal includes analyzing the magnitude of the detection signal to supply a magnitude value, and determining from the magnitude value the location of the handheld device within the reference area.

3. The method according to claim 1, wherein analyzing the detection signal includes analyzing the phase of the detection signal to supply a phase value, and determining from the phase value the location of the handheld device within the reference area.

4. The method according to claim 1, comprising:
arranging at least two electric field and/or magnetic field probes proximate to or inside the reference area,
receiving from the probes at least two detection signals, and
determining the location of the handheld device within the reference area from the phase difference between the detection signals.

5. The method according to claim 1, comprising:
arranging at least two electric field and/or magnetic field probes proximate to or inside the reference area,
receiving from the probes at least two detection signals, and
determining the location of the handheld device within the reference area from the magnitudes of the detection signals.

6. The method according to claim 1, comprising:
arranging at least three electric field and/or magnetic field probes proximate to or inside the reference area,
receiving from the probes at least three detection signals,
determining a first phase difference between a first pair of detection signals,
determining at least a second phase difference between a second pair of detection signals, and
determining the location of the handheld device within the reference area from the first and second phase differences.

7. The method according to claim 1, comprising:
defining predetermined locations within the reference area,
analyzing the detection signal supplied by the probe, and
determining therefrom in which predetermined location the handheld device is located.

8. The method according to claim 7, further comprising calibration, wherein the calibration includes recording, for each predetermined location, a set of magnitude and/or phase values of the detection signals when the handheld device is placed in the predetermined location.

9. A man/machine interface system for use with a handheld device emitting an electric field and/or magnetic field, the interface system comprising:
at least one electric field and/or magnetic field probe supplying a detection signal; and
a device coupled to the probe, the device being configured to:
analyze the detection signal,
determine therefrom the location of the handheld device within a reference area, and
initiate at least one interactive action depending upon the location of the handheld device.

10. The man/machine interface system according to claim 9, wherein the device is configured to determine the location of the handheld device from the magnitude value of the detection signal.

11. The man/machine interface system according to claim 9, wherein the device is configured to determine the location of the handheld device from the phase value of the detection signal.

12. The man/machine interface system according to claim 9, comprising at least two electric field and/or magnetic field probes proximate to or inside the reference area, supplying detection signals, and wherein the device is configured to determine the location of the handheld device within the reference area from the phase difference between the detection signals.

13. The man/machine interface system according to claim 9, comprising at least two electric field and/or magnetic field probes proximate to or inside the reference area, supplying detection signals, and wherein the device is configured to determine the location of the handheld device within the reference area from the magnitudes of the detection signals.

14. The man/machine interface system according to claim 9, comprising at least three electric field and/or magnetic field probes proximate to or inside the reference area, the probes supplying detection signals, the device being configured to:
determine a first phase difference between a first pair of detection signals,
determine at least a second phase difference between a second pair of detection signals, and
determine the location of the handheld device within the reference area from the first and second phase differences.

15. The man/machine interface system according to claim 9, the device being further configured to:
memorize predetermined locations within the reference area,
associate at least one interactive action to each predetermined location of the handheld device,
determine, from the detection signal, in which predetermined location the handheld device is located, and
initiate the interactive action that is associated with the location of the handheld device.

16. The man/machine interface system according to claim 15, wherein the device is further configured to perform a calibration including storing, for each predetermined location, a set of magnitude and/or phase values of the detection signals when the handheld device is placed on the location.
